(19) United States
(12) Patent Application Publication
(10) Pub. No.: US 2026/0044913 A1
(43) Pub. Date: Feb. 12, 2026

(54) METHOD AND SYSTEM FOR SHARING VIDEO RECORDING UPON EXPIRY OF A USER

(71) Applicant: Almeta Slater-Rogers, Old Hickory, TN (US)

(72) Inventor: Almeta Slater-Rogers, Old Hickory, TN (US)

(21) Appl. No.: 19/186,947

(22) Filed: Apr. 23, 2025

Related U.S. Application Data
(60) Provisional application No. 63/681,561, filed on Aug. 9, 2024.

(51) Int. Cl. G06Q 50/18; G06F 16/71; G11B 27/036; H04N 5/91

(52) U.S. Cl. CPC G06Q 50/186; G06F 16/71; G11B 27/036; H04N 5/91

(57) ABSTRACT

There is provided a method for sharing video recording of a first user with a second user. The method is performed by a memory creation engine. The method comprises enabling the first user to create a video recording via a first user device. The video recording is indicative of personal moments between the first user and the second user. The method comprises receiving from the first user, contact information of the second user. The method comprises storing the video recording in a user video database. The method comprises receiving, from the second user via a second user device, a request to access the stored video recording. The method comprises determining whether the first user has expired. The method comprises, upon a determination that the first user has expired, enabling the second user to access the video recording of the first user.

### CROSS-REFERENCE TO RELATED APPLICATION

This application claims the benefit of U.S. Provisional Patent Application Ser. No. 63/681,561 filed on Aug. 9, 2024, which is incorporated by reference herein in its entirety.

### FIELD OF THE INVENTION

The present invention relates generally to video sharing, and more particularly, to method and system for allowing a user to shar video recording with private moments with another user after expiry of the user.

### BACKGROUND OF THE INVENTION

In recent years, the spread of digital communication technologies has transformed how individuals interact and share information. Traditional digital communication platforms, including social media networks and messaging services, are primarily designed for real-time, public, or semi-public sharing of information. Existing platforms are configured to facilitate immediate interactions but fall short in addressing the nuances of privacy and delayed content delivery.

For example, once a message or video is shared on a social media platform, it is often accessible to a broad audience and may remain online indefinitely, posing risks of unintentional exposure or misuse. Additionally, existing platforms lack mechanisms for securely managing and controlling sensitive content that is intended to be shared only under specific conditions, such as after the sender's death.

Further, current digital legacy solutions generally focus on the transfer of tangible assets or digital accounts, such as social media profiles or financial accounts, upon an individual's death. While the existing solutions provide mechanisms for account management and inheritance, they do not adequately address the emotional and personal aspects of communication.

For instance, most existing services either automate the closure of accounts or transfer of data without considering the content's intended emotional impact or timing. Consequently, there is a gap in solutions that allow individuals to leave behind personalized, confidential messages that are delivered in a controlled manner after their passing.

Further, privacy and security remain paramount concerns in the realm of digital communications. Many existing platforms and services lack robust mechanisms for ensuring that sensitive content is accessed only by the intended recipients and at the appropriate time. Traditional digital inheritance solutions often fail to incorporate comprehensive verification processes to confirm the death of the individual before granting access to their stored content. This can lead to potential breaches of privacy and compromise the confidentiality of the information, undermining the integrity of the intended communication.

Moreover, the current state of digital communication tools does not fully capture the emotional depth and personal touch that individuals might wish to convey through their final messages. While written letters and photographs have been traditional methods for leaving personal messages, they lack the dynamic and engaging nature of video content. Videos offer a richer medium for expressing emotions and personal stories, which can be more impactful and memorable than static text or images.

Accordingly, there is need for a solution to at least one of the aforementioned problems. For instance, there is an established need for systems and methods that provide a secure, private, and emotionally resonant way to leave behind personal messages. Further, there is an established need for systems and methods that allow creation and controlled delivery of private moments after an individual's death. Further, there is an established need for systems and methods that provide a unique and controlled method for individuals to leave behind a lasting, personal legacy.

### SUMMARY OF THE INVENTION

The present invention is directed to a method for sharing video recording of a first user with a second user. The method comprises enabling, by a memory creation engine, the first user to create a video recording via a first user device associated with the first user. The video recording is indicative of personal moments between the first user and the second user. The method comprises receiving, by the memory creation engine from the first user via the first user device, contact information of the second user. The method comprises storing, by the memory creation engine, the video recording of the first user in a user video database. The method comprises receiving, by the memory creation engine from the second user via a second user device associated with the second user, a request to access the stored video recording. The method comprises determining, by the memory creation engine, whether the first user has expired. The method comprises, upon a determination that the first user has expired, enabling, by the memory creation engine, the second user to access the video recording of the first user.

In an aspect, receiving the contact information of the second user may comprise receiving one or more of name, email, mobile number, and relationship of the second user.

In an aspect, the method may further comprise enabling the first user to customize the video recording

In an aspect, customizing the video recording may include receiving a user input indicative of selection of background, filter, and/or music, and further, adding the selected background, filter, and/or music to the video recording.

In an aspect, receiving the request to access the stored video recording may comprise generating a unique access code, sharing the unique access code with the second user, and enabling the second user to access the video recording by referencing the unique access code.

In an aspect, determining whether the first user has expired may comprise retrieving, via one or more audit units, data associated with the first user from remote servers.

In an aspect, determining whether the first user has expired may comprise receiving, from the second user via the second user device, a death certificate indicative of death of the first user.

In an aspect, determining whether the first user has expired may comprise comparing the data retrieved by the one or more audit units, personal data associated with the first user stored in a user profile database, and data read from the death certificate, and further, upon a result of the comparison indicating that a data match, concluding that the first user has expired.

In an aspect, the method may further comprise enabling the first user to pay for the video creating, sharing, and storing services.

In an aspect, enabling the second user to access the video recording of the first user may comprise enabling the second user to download the video recording on the second user device.

In an aspect, the method may further comprise permanently deleting the video recording from the user video database upon a determination that the second user has accessed the video recording.

The present invention is further directed to a memory creation engine comprising one or more processors operatively coupled to memory that stores instructions, which in response to execution by the one or more processors cause the one or more processors to perform or control perform operations corresponding to any of the methods disclosed herein.

Moreover, the present invention is further directed to a non-transitory computer readable storage medium that comprises instructions, which in response to execution by the one or more processors cause the one or more processors to perform or control perform operations corresponding to any of the methods disclosed herein.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1A illustrates a schematic representation of an exemplary system having a memory creation engine, in accordance with a non-limiting embodiment of the present invention;

FIG. 1B illustrates a block diagram depicting an exemplary configuration of the memory creation engine, in accordance with a non-limiting embodiment of the present invention;

FIG. 2A illustrates a screen capture of an exemplary interface displayed on the first user device when the first user initially accesses the platform, in accordance with a non-limiting embodiment of the present invention;

FIG. 2B illustrates a screen capture of an exemplary interface displayed on the first user device to set up payment methods, in accordance with a non-limiting embodiment of the present invention;

FIGS. 3A-3D illustrate screen captures of exemplary interfaces displayed on the first user device to enable the first user to curate and store the video recording, in accordance with non-limiting embodiments of the present invention;

FIGS. 4A-4C illustrate screen captures of exemplary interfaces displayed on the second user device to enable the second user to retrieve the video recording created by the first user, in accordance with non-limiting embodiments of the present invention;

FIG. 5 illustrates a flowchart of a method for sharing video recording of a first user with a second user, in accordance with a non-limiting embodiment of the present invention;

FIG. 6 illustrates a schematic representation of an example computer-readable storage medium, in accordance with a non-limiting embodiment of the present invention; and

FIGS. 7A-7D illustrate screen captures of exemplary interfaces displayed on the first user device to enable the first user to publish the memory, in accordance with non-limiting embodiments of the present invention.

Like reference numerals refer to like parts throughout the several views of the drawings.

### DETAILED DESCRIPTION

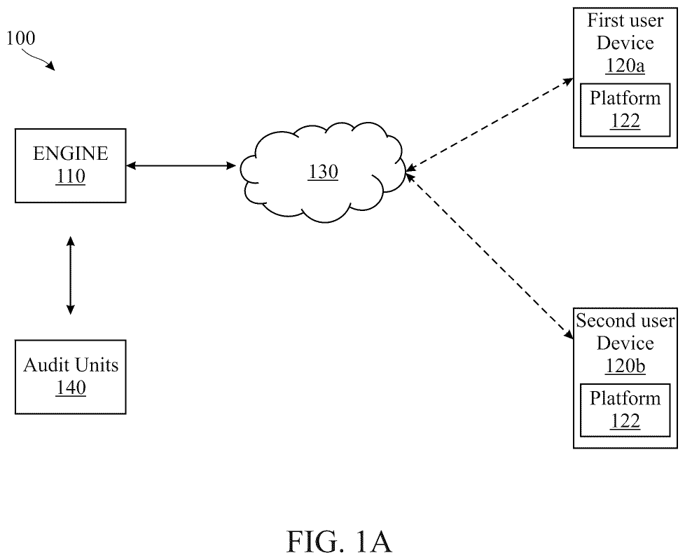

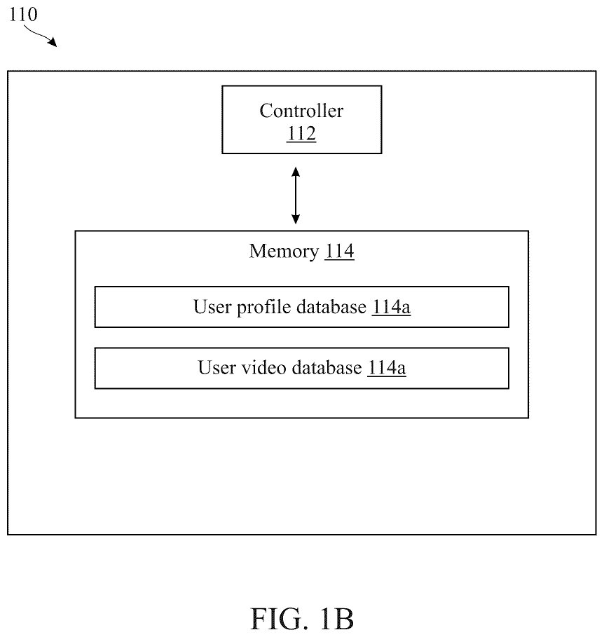

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1A. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In the following description, certain specific details are set forth in order to provide a thorough understanding of various disclosed implementations. However, one skilled in the relevant art will recognize that implementations may be practiced without one or more of these specific details, or with other methods, components, materials, and the like.

Unless the context requires otherwise, throughout the specification and claims which follow, the word “comprise” and variations thereof, such as, “comprises” and “comprising” are to be construed in an open, inclusive sense, that is as “including, but not limited to.”

As used in this specification and the appended claims, the singular forms “a,” “an,” and “the” include plural referents unless the content clearly dictates otherwise. It should also be noted that the term “or” is generally employed in its broadest sense, which is as meaning “and/or” unless the content clearly dictates otherwise.

The headings and Abstract of the Disclosure provided herein are for convenience only and do not interpret the scope or meaning of the implementations.

Referring initially to FIG. 1A, a schematic diagram of an exemplary system 100 is illustrated. The system 100 comprises a memory creation engine 110 (hereinafter referred to as the engine 110) and a plurality of user devices comprising a first user device 120a and a second user device 120b. The first user device 120a may be associated with a first user, the first user being a memory creator. The second user device 120b may be associated with a second user, the second user being a memory receiver.

The memory creator refers to a person who has curated, customized and published video recording(s) of themselves detailing personal and private moments related to the memory receiver. The memory receiver refers to a person to whom the video recording is sent privately, i.e., a person who will receive the memory creator's personal and private video recording. The memory creator's personal and private video recording is shared with the memory receiver only after the death of the memory creator.

Hereinafter, the terms “first user” and “memory creator” may be used interchangeably. Further, the terms “second user”and “memory receiver”may be used interchangeably.

It is appreciated that FIG. 1A depicts the second user device 120b associated with one memory receiver for sake of simplicity. The system 100 may include multiple other user devices associated with multiple memory receivers. The details described with the respect to the second user device 120b and the second user (memory receiver) are equally applicable for each of the multiple memory receivers without departing from the scope of the invention. For instance, the memory creator may curate private and person video recordings for each of the multiple memory receivers and each of the multiple memory receivers may receive the respective video recording from the memory creator after the death of the memory creator.

Further, although the FIG. 1A depicts the first user device 120a associated with one memory creator, the system 100 may include multiple memory creators, each memory creator being enabled to curate and publish personal video recording for one or more memory receivers.

The first user device 120a and the second user device 120b may be in communication with the engine 110. The system 100 comprising the engine 110 and the user devices 120a, 120b form a networked environment to facilitate communication and exchange of information among the engine 110 and the user devices 120a, 120b.

The system 100 comprises a communication network 130 that allows communication among the engine 110 and the user devices 120a, 120b. The network 130 may be any type of communication network including one or more of the Internet, local area networks (LAN), wireless networks, switch or hub connections, a telephone network (e.g., a public switched telephone (PSTN) network, a cellular network, etc.), or the like.

In some embodiments, the engine 110 may comprise a computer, e.g., a server computer, or a dedicated host device that facilitates communication with the user devices 120a, 120b. In some embodiments, the engine 110 may be implemented as a cloud-based server. In some embodiments, the engine 110 may be implemented using cloud computing, distributed computing, virtualized computing, or the like. In some embodiments, one or more functions of the engine 110 may be performed by one or more components of the cloud server.

The engine 110 may be configured to manage and control communication between the engine 110 and the user devices 120a, 120b. The user devices 120a, 120b may each comprise a digital platform 122 (shown with respect to the first user device 120a in FIG. 1A). The digital platform 122, or simply “the platform 122,” may be an application configured to facilitate communication between the engine 110 and the user devices 120a, 120b. In some embodiments, the digital platform 122 may be a software application, a web-based application, an on-device application (mobile application), a webpage, and the like. In an embodiment, the mobile application may be installed on the corresponding user devices.

The system 100 may further include audit units 140 configured to provide death verification services. The audit units 140 may be in communication with the engine 110. The engine 110 may employ the audit units 140 for accessing records regarding deaths of individuals. The records may be stored in remote servers. In an embodiment, the records may be maintained by the government. The engine 110 may request the audit units 140 to verify death of the first user, when required. The audit units 140 may be in communication with the remote servers to access the records and verify whether the first user has expired, as will be described further below.

The first user (memory creator) may utilize the platform 122 to curate and publish video recordings while the second user (memory receiver) may utilize the platform 122 to retrieve the video recordings of the first user (memory creator).

The user devices 120a, 120b may include any type of electronic device including, but not limited to, desktop computer, laptop computer, portable or mobile device, cell phone, smartphone, tablet computer, personal digital assistant (PDA), wearable device, or the like.

In some embodiments, the first user device 120a includes the digital platform 122, as depicted. The digital platform 122 may be configured to provide user interfaces on a display unit associated with the first user device 120a. The user interfaces may be provided for display under control of the engine 110. The user interfaces provided by the digital platform 122 enables the first user (memory creator) to provide inputs to the first user device 120a and interact with the engine 110 via the digital platform 122.

In some embodiments, the second user device 120b includes the digital platform 122, as depicted. The digital platform 122 may be configured to provide user interfaces on a display unit associated with the second user device 120b. The user interfaces may be provided for display under control of the engine 110. The user interfaces provided by the digital platform 122 enables the second user (memory receiver) to provide inputs to the second user device 120b and interact with the engine 110 via the digital platform 122.

Referring to FIG. 1B, a schematic representation is shown of an exemplary configuration of the engine 110. The engine 110 comprises a controller 112 in communication with a memory 114. The controller 112 is configured to execute instructions stored in the memory 114. For instance, the controller 112 coordinates with the memory 114 to execute instructions to perform or control performance of methods described herein.

In some implementations, the controller 112 may comprise at least one processor in communication with at least one non-transitory processor-readable medium. The processor-readable medium may have instructions stored thereon which when executed cause the processors to control and manage operations of the engine and the user devices. Furthermore, in some implementations, the controller or its functionality may be implemented in other ways, including: via Application Specific Integrated Circuits (ASICs), in standard integrated circuits, as one or more computer programs executed by one or more computers (e.g., as one or more programs running on one or more computer systems), as one or more programs executed by on one or more controllers (e.g., microcontrollers), as one or more programs executed by one or more processors (e.g., microprocessors, central processing units, graphical processing units), as firmware, and the like, or as a combination thereof.

Memory 114 may include a non-transitory machine-readable storage medium that may be any electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, a storage drive, an optical disc, or the like. The machine-readable storage medium may be encoded with executable instructions. In some implementations, memory 114 may comprise a cloud-based storage. The memory may store various types of data in databases such as user profile database 114a and user video database 114b.

Controller 112, in turn, may include a central processing unit (CPU), a graphics processing unit (GPU), a microcontroller, a microprocessor, a processing core, a field-programmable gate array (FPGA), or similar device capable of executing instructions. In some implementations, controller 112 may comprise a cloud based or virtualized processing module or functionality.

The controller 112 is configured to communicate with the digital platform 122 and provide controls and commands to the digital platform 122. In an embodiment, the controller 112 may be configured to instruct the digital platform 122 to receive inputs/information from the first user associated with the first user device 120a, for instance, by means of a user interface. In some embodiments, the controller 112 may be configured to instruct the digital platform 122 to present information on the display unit of the first user device 120a.

The controller 112 may be configured to communicate with the platform 122 and provide controls and commands to the platform 122. In an embodiment, the controller 112 may be configured to instruct the platform 122 to receive inputs/information from the first user associated with the first user device 120a, for instance, by means of a user interface presented on the display unit of the first user device 120a. In some embodiments, the controller 112 may be configured to instruct the platform 122 to present information on the display unit of the first user device 120a. The platform 122 under control of the engine 110 may facilitate the first user to set up an account, curate video recording, and securely store the video recordings via the first user device 120a. It is appreciated that the steps and functionalities of the engine 110 may inherently refer to the steps and functionalities of the controller or processor of the engine 110.

In one aspect, the first user device 120a may include a device processor/controller, a device memory, and a display unit communicatively coupled with each other. The device processor may be configured to perform or control various operations of the user device, as would be generally understood. Further, it is appreciated that displaying of information/details on the first user device 120a inherently means that the information/details are displayed by means of the display unit of the first user device 120a, unless specified otherwise. Further, it is to be understood that functionalities being performed by the platform 122 would be under the control of the engine 110, in that, the platform 122 being configured to perform a function is to be understood as the engine 110 instructing the platform 122 to perform the function. The engine 110 and the platform 122 may communicate with each other in order to implement the techniques consistent with the present disclosure.

In one embodiment, the first user looking to create video recordings may utilize the video recording services provided by the engine 110 via the platform 122. The first user may access and register themselves using the first user device 120a. For example, the first user may connect the first user device 120a with the Internet and access the platform 122 on the first user device 120a. In an embodiment, the platform 122 may be installed on the first user device 120a, for instance, when the platform 122 is a mobile application. In an embodiment, the platform 122 may be accessed via a web portal.

Initially, the first user may access the platform 122 and the engine 110. In an embodiment, the platform 122 may request the first user to select whether the first user wants to access the platform 122 as a memory creator or a memory receiver. In the present case, the first user is a memory creator. The platform 122 may present selectable options on the first user device 120a and the first user may select the relevant option indicating that the first user wants to access the platform 122 as a memory creator.

In an embodiment, the platform 122 may present a login interface on the first user device 120a and request the user to provide access credentials. The access credential may include, for instance, username, email address, and password. The platform 122 may request for the access credentials from the first user. In an embodiment, the engine 110 may be configured to determine whether the first user is a registered user based on the received access credentials. In an embodiment, the memory 114 comprises pre-stored information regarding all the users registered with the engine 110 in the user profile database 114a. The engine 110 may be configured to receive the access credentials from the first user via the first user device 120a and compare the received access credentials with the pre-stored information.

In a scenario when the engine 110 determines that the first user is not a registered user, the engine 110 may instruct the platform 122 to present registration interface on the first user device 120a and request user information from the first user for registration. That is, in case the first user is a new user, the first user may create an account with the engine 110 via the digital platform 122 by providing user information. In an embodiment, the platform 122 may request personal details (such as name, age, birthdate, payment details, etc.) and access credentials (such as username, email address, password, etc.) from the user. The engine 110 may store the received personal information and access credentials of the first user in the user profile database 114a.

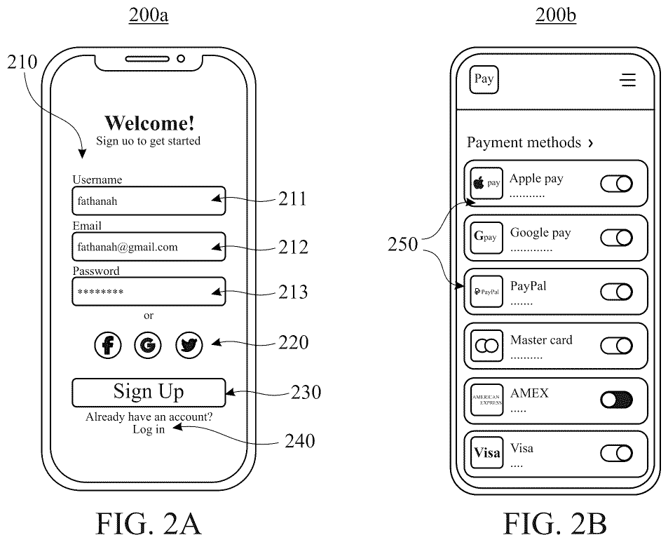

FIG. 2A illustrates a screen capture of an exemplary interface 200a which may be displayed by the platform 122 on the first user device 120a when the first user initially accesses the platform 122. The interface 200a may be displayed at the time of registration. For instance, the interface 200a may be a registration interface. The interface 200a may be displayed on the first user device 120a by the platform 122 under control of the engine 110 (for instance, the controller 112 of the engine 110). The interface 200a may enable the first user to register with the platform 122 or to create an account with the platform 122.

In an embodiment, the platform 122 may present access credential section 210 on the interface 200a. The access credential section 210 may include a username field 211, an email field 212, and a password field 213. The platform 122 may be configured to receive username of the first user at the username 211, the email address of the first user at the email field 212, and the password of the first user at the password 213 presented on the interface 200a.

In an embodiment, the interface 200a may also include a personal detail section to enable the first user to input personal details, such as, name, age, photo, etc.

In an embodiment, the platform 122 may present a social media section 220 to enable the first user to link one or more social media accounts with the platform 122. The social media section 220 may be used in place of the access credentials, in that, the social media account of the first user may act as the access credentials.

In an embodiment, the platform 122 may present a sign-up button 230 to enable the first user to complete registration with the platform 122. In an embodiment, the platform 122 may present a login button 240 for use in case the first user is already registered with the platform 122. For instance, when the first user is already registered with the platform 122, the user may click on the login button 240. Upon receiving the user input indicative of clicking on the login button 240, the platform 122 may present the login interface on the first user device 120a and request access credentials from the user to access the platform 122. On the login interface, the first user may input already established access credentials to access the platform 122.

In an embodiment, the engine 110 and the platform 122 may provide a subscription-based service. The first user may pay a subscription fee to use the services provided by the platform 122, which may include curating of video recordings and storing of video recordings.

FIG. 2B illustrates a screen capture of an exemplary interface 200b which may be displayed by the platform 122 on the first user device 120a to set up payment methods. The platform 122 may present the interface 200b, i.e., a payment interface 200b to enable the first user to set up the payment methods. The platform 122 may present a plurality of payment options 250 on the interface 200b. The platform 122 may receive a user input indicative of selection of a particular payment option among the plurality of payments options 250. In an embodiment, the first user may select multiple payment options. In an embodiment, the engine 110 may be configured to link the selected payment options with the backend payment facilities in order to enable the first user to carry out payments via the selected payments options. In non-limiting examples, the payment options 250 may include credit cards, debit cards, digital payments, and the like.

In an embodiment, once the first user has completed the registration via the registration interface, the engine 110 may instruct the platform 122 to present video recording interface on the first user device 120a to enable the first user to curate and/or customize video recordings. Also, in a scenario when the engine 110 determines that the first user is a registered user at the time of login, the engine 110 may instruct the platform 122 to present video recording interface on the first user device 120a upon successful login of the first user.

The engine 110 may enable the first user to curate and store a video recording to be shared with the second user (memory receiver) after the death of the first user. In an embodiment, the engine 110 may enable the first user to record a video. In an embodiment, the engine 110 may enable the first user to record the video via a camera unit associated with the first user device 120a. The video may be recorded in a selfie mode, wherein the face of the first user is visible. The video may be recorded for a pre-defined time period. For instance, in a non-limiting example, the video may be recorded for a period of 30 seconds to 3 minutes.

The video recording that is recorded by the first user may include personal and private moments which the first user (memory creator) desires to share with the second user (memory receiver). The video recording may be confidential and hence the first user may share any moments or details as desired. There would be no awkwardness between the first user and the second user since the first user would have expired when the video recording would be shared with the second user.

In an embodiment, the engine 110 may enable the first user to customize the video recording. In an embodiment, the engine 110 may enable the first user to customize the video recording prior to recording the video and/or after recording the video. In an embodiment, the engine 110 may enable the first user to choose a suitable background for the video recording from multiple background options. In an embodiment, the engine 110 may enable the first user to add a filter to the video recording from multiple filter options. In an embodiment, the engine 110 may enable the first user to choose a suitable music to be added to the video recording from multiple music options.

As described above, the video recording may be curated to capture private moments to be shared with the second user. In an embodiment, the engine 110 may enable the first user to select a relationship with the second user. For instance, the engine 110 may enable the first user to select a relationship from multiple relationship options. The relationship options may include, for instance, spouse, child, parent, uncle, aunt, friend, frenemy, pet, etc.

In an embodiment, the engine 110 may enable the first user to provide contact details of the second user, so as to enable the engine 110 to communicate with the second user when the second user tries to retrieve the video recording created by the first user. For instance, the engine 110 may enable the first user to provide name, email address, and mobile number of the second user.

In an embodiment, the engine 110 may generate a unique access code for the second user. The unique access code may be provided to the second user, for instance, by email or via text message. Further, the unique access code may be referenced by the second user when the second user looks to retrieve the video recording curated by the first user.

In an embodiment, the engine 110 may publish and store the video recording in the user video database 114b. The video recording may be stored in the user video database 114b securely and may only be shared with the second user when the first user has expired. In an embodiment, the engine 110 may enable the first user to pay the subscription fee, which may include fee for curating and storing the video recording. The engine 110 may enable the first user to pay the subscription fee via any of the payment options previously selected by the first user.

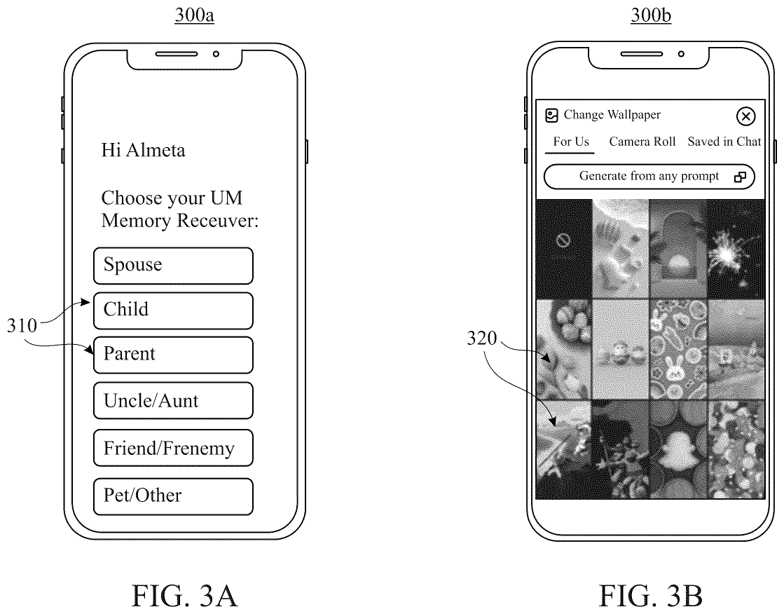

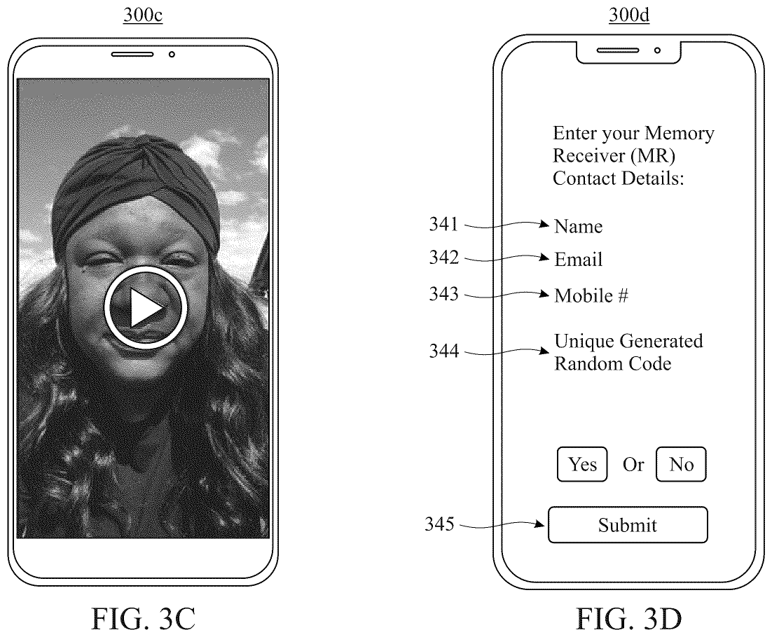

FIGS. 3A-3D illustrate screen captures of exemplary interfaces 300a-300d which may be displayed by the platform 122, under control of the engine 110, on the first user device 120a to enable the first user to curate and store the video recording. As seen in FIG. 3A, the platform 122 may display the interface 300a for requesting the first user to select relationship with the second user, i.e., the memory receiver. The platform 122 may present multiple relationship options 310 on the first user device 120a. The first user may select a suitable relationship from among the relationship options 310. The relationship options 310 may include, for instance, spouse, child, parent, uncle, aunt, friend, frenemy, pet, and the like. The platform 122 may receive a user input indicative of the selection of the suitable relationship from among the relationship options 310. In an embodiment, the user selection of the relationship with the second user may be stored in the user profile data 114a.

As seen in FIG. 3B, the platform 122 may display the interface 300b for requesting the first user to select a suitable background from multiple backgrounds 320. The platform 122 may receive a user input indicative of the selection of the suitable background from among the background options 320. The selected background may be added to the video recording of the first user.

As seen in FIG. 3C, the platform 122 may display the interface 300c for requesting the first user to record the video. In an embodiment, the platform 122 may activate the camera unit of the first user device 120a in order to enable the first user to record the video. The first user may then proceed to record the video. In an embodiment, the video recording may be of a pre-defined length, such as, 30 seconds to 3 minutes.

In an embodiment, the platform 122 may further request the user to add filters and/or music to the video recording, if required. In an embodiment, the platform 122 may further request the user to select suitable filters and/or suitable music at the time of selecting the suitable background. In an embodiment, the platform 122 may further request the user to select suitable filters and/or suitable music after the video recording has been captured, wherein the selected filter and/or music may then be added to the video recording.

In an embodiment, the platform 122 may further request the user to carry out payment for the services provided by the platform 122. The payment may include the subscription fee for using the services of the platform 122. In an embodiment, the subscription fee may include fee for curating and storing the video recording.

As seen in FIG. 3D, the platform 122 may display the interface 300d for requesting the first user to provide contact details of the second user. The platform 122 may present input fields on the first user device 120a, the input fields include name field 341, email field 342, and mobile number field 343. The platform 122 may receive the name of the second user at the name field 341. The platform 122 may receive the email address of the second user at the email field 342. The platform 122 may receive the mobile number of the second user at the mobile number field 343.

In an embodiment, the engine 110 may generate the unique access code associated with the video recording created by the first user, as depicted by numeral 344. The platform 122 may further present a submit button 345. The first user may click on the submit button 345 to complete the video recording process and publish the video recording to the user video database 114b. The video recording may be stored in the user video database 114b, along with the details of the second user, till the time the video recording is retrieved by the second user after the death of the first user.

In an embodiment, the engine 110 may send the unique access code to the second user via email or text message. The unique access code may be referenced by the second user when the second user desires to retrieve the video recording, however, the video recording can be retrieved from the user video database 114b only after the death of the first user. After the death of the first user, the second user may reference the unique access code to initiate the retrieval process of the video recording.

As described above, the second user (memory receiver) may be associated with the second user device 120b, the second user device 120b also configured to access the platform 122. After the first user has expired, which may be any amount of time after the first user has created the video recording, the second user may access the platform 122 via the second user device 120b. In an embodiment, the second user may access the platform 122 in the form of an application on the second user device 120b or via a web portal in the second user device 120b.

In an embodiment, the second user may reference the unique access code in the email or text message received from the engine 110. In an embodiment, the email or text message may additionally include a link to access the platform 122 (for e.g., link to download application or link to website). The unique access code may be received by the second user when the first user has created the video recording, however, the second user would be able to access the video recording only after the first user has expired. In an embodiment, the engine 110 may be configured to determine whether the first user has expired. In case the first user has expired, the engine 110 may allow the second user to retrieve the video recording.

When the second user desires to retrieve the video recording, the second user may access the platform 122 via the second user device 120b. In an embodiment, the platform 122 may request the second user to select whether the second user wants to access the platform 122 as a memory creator or a memory receiver. In the present case, the second user is a memory receiver. The platform 122 may present selectable options on the second user device 120b and the second user may select the relevant option indicating that the second user wants to access the platform 122 as a memory receiver.

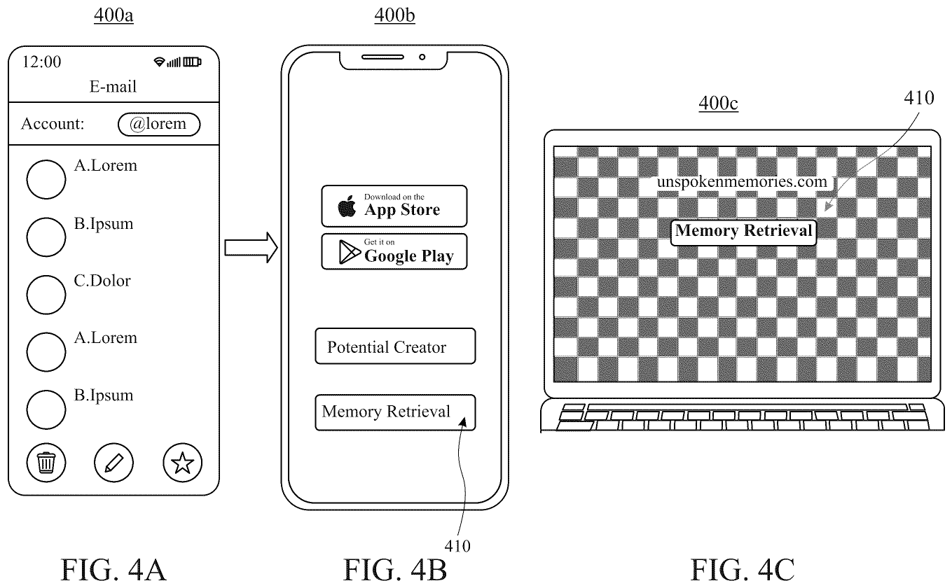

FIGS. 4A-4C illustrate screen captures of exemplary interfaces 400a-400c which may be displayed by the platform 122, under control of the engine 110, on the second user device 120b to enable the second user to retrieve the video recording created by the first user. As depicted in FIG. 4A, the second user may reference the email with the unique access code and optionally, a link to access the platform 122. In the embodiment illustrated in FIG. 4B, the second user may access the platform 122 as a software application. In the embodiment illustrated in FIG. 4C, the second user may access the platform 122 as a website portal. In an embodiment, the second user may click on the memory retrieval option 410 so as to initiate the process of retrieving the video recording created by the first user.

The engine 110 may be configured to determine whether the first user has expired. That is, the engine 110 may be configured to verify whether the first user has expired. In an embodiment, the engine 110 may utilize the audit units 140 to extract information regarding the death of the first user. The engine 110 may share the personal details of the first user, such as the name, date of birth, etc., with the audit units 140. In an embodiment, the engine 110 may communicate with the audit units 140 via Application Programming Interface (API) or using SSH File Transfer Protocol (sFTP). The audit units 140 may be configured to retrieve data from remote servers that match the personal details of the first user. The engine 110 may receive the retrieved data from the audit units 140.

In an embodiment, the platform 122 may request the second user to upload a death certificate indicating the death of the first user. In an embodiment, the platform 122 may present an upload option on the second user device 120b in order to enable the second user to upload the death certificate. The engine 110 may be configured to read data from the uploaded death certificate and compare the data from the death certificate with the personal details of the first user stored in the user profile data 114a as well as with the data retrieved by the audit units 140. Based on the comparison, the engine 110 may determine whether or not the first user has expired. For instance, in case the details match, the engine 110 may determine that the first user has expired.

In an embodiment, the engine 110 may cross-check whether the first user has expired. Upon successful matching of the details in the death certificate with the details available with the engine 110, the engine 110 may transmit a message to the first user device 120a of the first user. The message may be transmitted as an email and/or a text message. The message may include a request to reply to the message in case the first user has not expired. As a result, in case the first user is alive, the first user may send a reply to the message. In such a scenario, the engine 110 may determine that the first user has not expired.

Once the engine 110 determines that the first user has expired, the engine 110 may allow the second user to retrieve the video recording of the first user from the user video database 114b. In an embodiment, the second user may download the video recording to the second user device 120b from the user video database 114b. Further, by virtue of the unique access code, the engine 110 may enable the second user to access only the video recording meant for the second user, and not video recording meant for other users, if any.

In an embodiment, the engine 110 may determine whether the second user has retrieved the video recording. Upon a confirmation that the second user has retrieved the video recording, the engine 110 may permanently delete the video recording from the user video database 114b. Further, in case there are any additional video recordings for other users, the engine 110 may determine that the other users have also retrieved the additional video recordings. Once the engine 110 determines that all the video recordings created by the first user have been retrieved by the respective memory receivers, the engine 110 may permanently delete the details of the first user from the user profile database 114a as well as all the video recordings from the user video database 114b.

In an embodiment, the engine 110 may check, using the audit units 140, whether any pending litigation or any legal matters are pending to be resolved for the first user. In such a scenario, the engine 110 may keep the video recordings of the first user in the memory 114 till the legal matters are resolved.

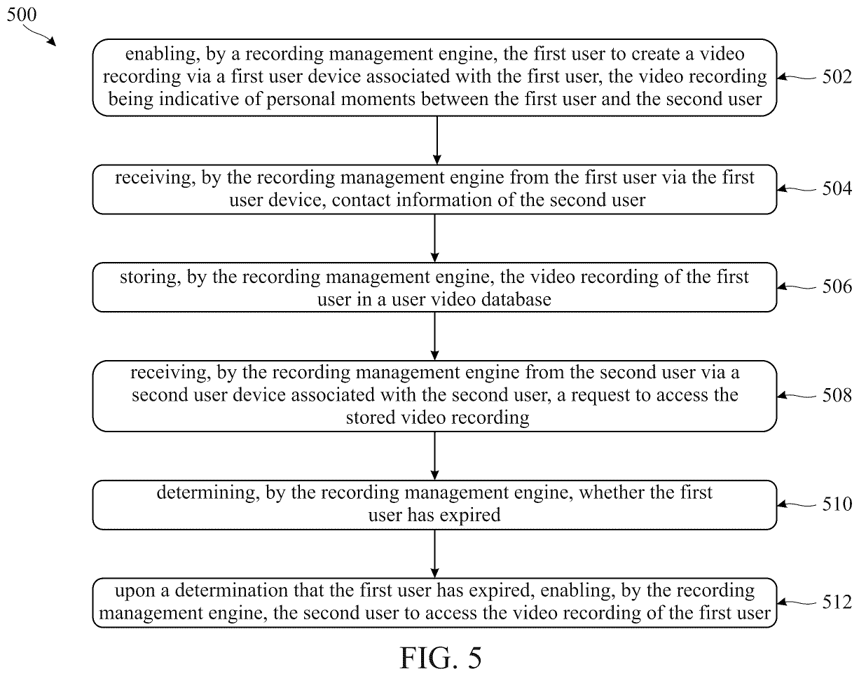

Reference is now made to FIG. 5 which illustrates a flowchart of an example method 500 for facilitating sharing of video recording of the first user with the second user. The method 500 may be performed by the engine 110 in coordination with the platform 122.
At step 502, the engine 110 may enable the first user to create a video recording via the first user device 120a associated with the first user. The video recording may be indicative of personal moments between the first user and the second user.
At step 504, the engine 110 may receive contact information of the second user from the first user.
At step 506, the engine 110 may store the video recording of the first user in the user video database 114b.
At step 508, the engine 110 may receive a request to access the video recording from the second user via the second user device 120b.
At step 510, the engine 110 may determine whether the first user has expired.
At step 512, the engine 110 may enable the second user to access the video recording of the first user upon a determination that the first user has expired.

A detailed description related to the various steps of FIG. 5 is already covered in the description related to FIGS. 1A-4C and is omitted herein for the sake of brevity. It is appreciated that the method steps described above with respect to FIG. 5 may be performed in a different order, and further, may be performed repeatedly.

In some embodiments, the engine 110 may be configured to execute instructions included in a computer program product. The computer program product may be embodied on a non-transitory computer readable medium. The computer program product may comprise instructions that, when executed by the engine 110, cause the engine 110 to perform the method as described herein

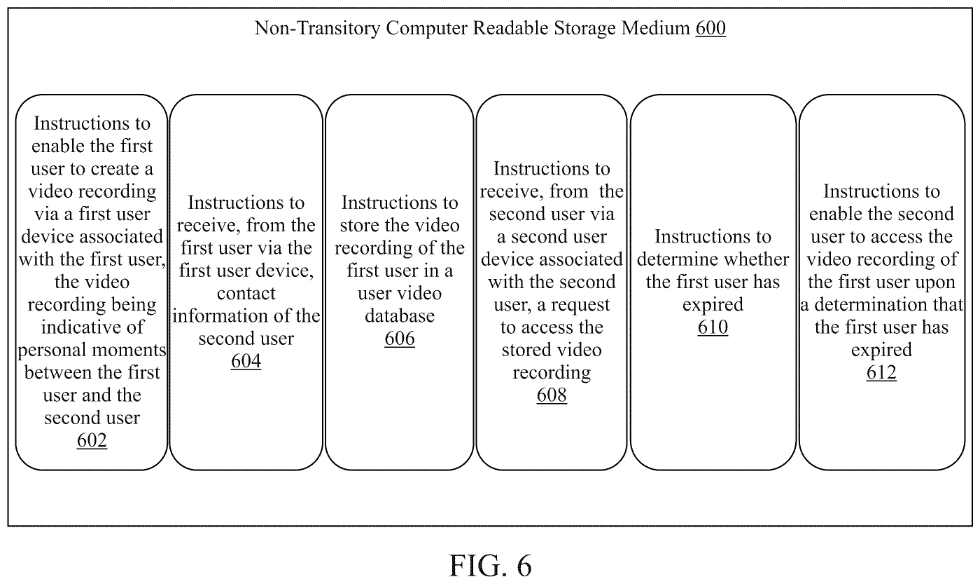

Turning now to FIG. 6, an example non-transitory computer-readable storage medium (CRSM) 600 is shown, in which CRSM 600 comprises instructions executable by the engine 110, in particular the controller or processor of the engine 110. The CRSM 600 may comprise any electronic, magnetic, optical, or other physical storage device that stores executable instructions. The instructions may comprise instructions to cause the engine 110 to perform or control performance of operations of the example method 500 and the other methods described herein.

The instructions may comprise instructions 602 to enable the first user to create a video recording via the first user device 120a associated with the first user. The video recording being indicative of personal moments between the first user and the second user.

The instructions may comprise instructions 604 to receive, from the first user via the first user device 120a, contact information of the second user.

The instructions may comprise instructions 606 to store the video recording of the first user in a user video database 114b.

The instructions may comprise instructions 608 to receive, from the second user via the second user device 120b associated with the second user, a request to access the stored video recording.

The instructions may comprise instructions 610 to determine whether the first user has expired.

The instructions may comprise instructions 612 to enable the second user to access the video recording of the first user upon a determination that the first user has expired.

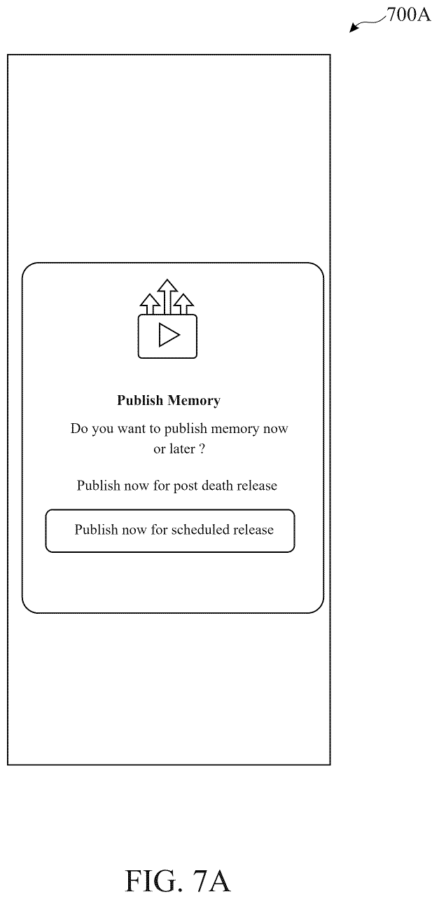

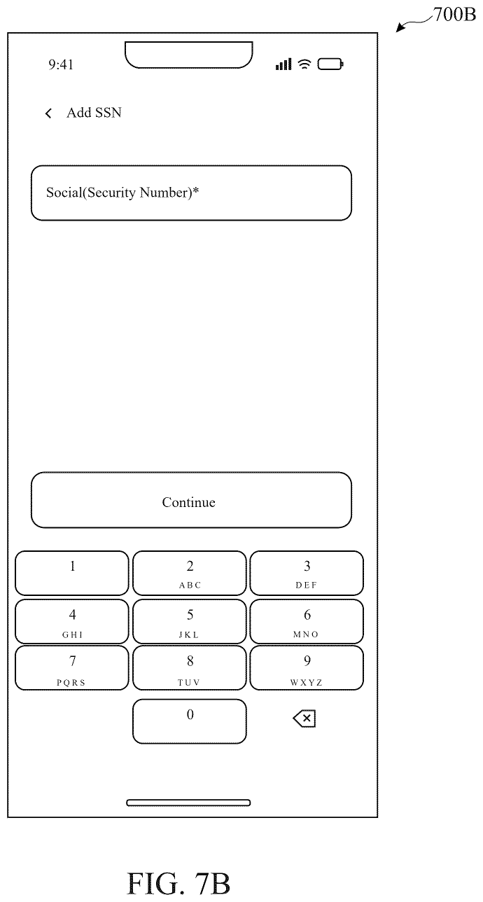

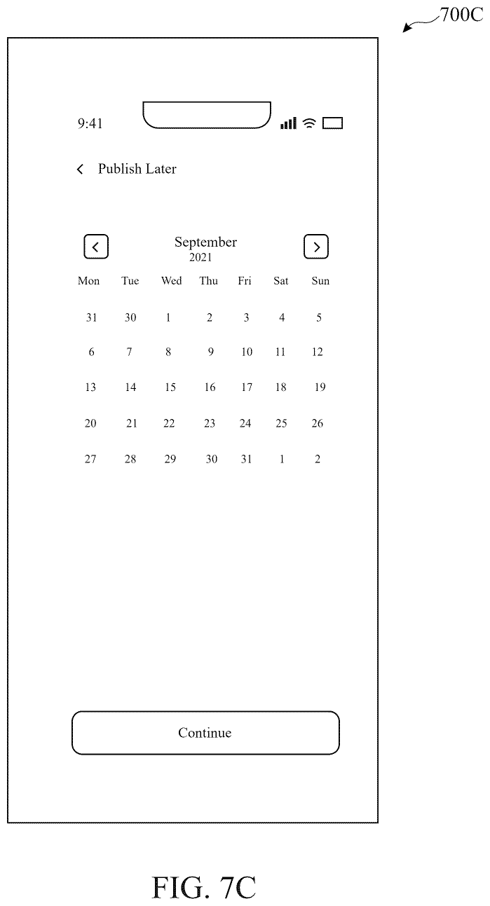

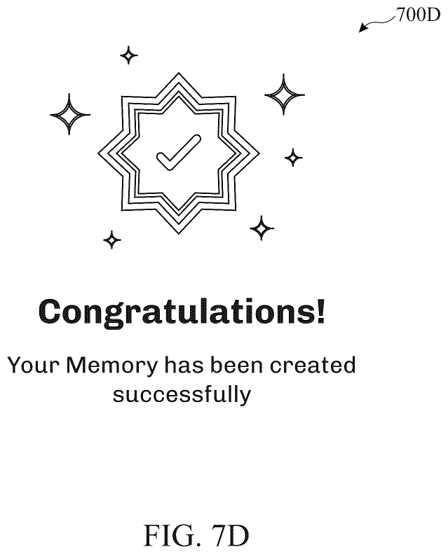

FIG. 7A illustrates a screen capture of an exemplary interface 700a which may be displayed by the platform 122 on the first user device 120a when the first user has curated the memory. As seen in the interface 700, the first user is displayed multiple options for the first user to select i.e., an option for the first user to publish memory now, which is to be released post-death of the first user, and an option for the first user to publish memory now and to be-released at the scheduled time selected by the first user. As seen in FIG. 7C, which shows the exemplary interface 700C, the first user is enabled to select a date and/or time period on the calendar displayed for the memory to be released at the selected time and date. Therefore, the present invention also enables the user to create the memory by the creator, which is released to designated recipients at the time scheduled by the first user.

FIG. 7B illustrates a screen capture of an exemplary interface 700B which may be displayed by the platform 122 on the first user device 120a for the first user or memory creator to provide their social security number (SSN), if the first user selects the memory to be release post-death of the first user. The first user may not be required to provide the SSN if the first user creates a memory for it to be released at the scheduled time period.

FIG. 7D illustrates a screen capture of an exemplary interface 700D, which shows a notification or confirmation being shown or sent to the first user device 120a once the memory (e.g., video recording) is successfully created.

The system and method described herein offers numerous advantages. The system and method facilitate the creation and secure storage of personalized video messages, which are released to designated recipients solely upon verification of the memory creator's death. This mechanism ensures that content remains confidential and is accessed only by intended parties, preserving the integrity of the communication. The system incorporates a robust death verification protocol to authenticate the passing of the memory creator before granting access to the stored video, thus safeguarding against premature release. By leveraging video format over traditional text or image media, the system enhances engagement and emotional impact, offering a more dynamic form of legacy than conventional inheritance methods. Additionally, the service operates independently of social media platforms, thus avoiding public exposure and ensuring that the communication remains intimate and private. This technical approach provides a reliable and secure means for leaving a personalized digital legacy, supporting both generational transmission and individual privacy.

Accordingly, a secure, private, and emotionally resonant way to leave behind personal messages is provided. In particular, a service is provided where individuals can create and store personalized video messages that are shared only with designated recipients after their death. By integrating a secure storage system and a robust death verification process, the service ensures that content remains confidential, is delivered at the appropriate time, and maintains the emotional impact intended by the creator.

The methods described herein may be performed using the systems described herein. In addition, it is contemplated that the methods described herein may be performed using systems different than the systems described herein. Moreover, the systems described herein may perform the methods described herein and may perform or execute the instructions stored in the CRSMs described herein. It is also contemplated that the systems described herein may perform functions or execute instructions other than those described in relation to the methods and CRSMs described herein.

Furthermore, the CRSMs described herein may store instructions corresponding to the methods described herein and may store instructions which may be performed or executed by the systems described herein. Furthermore, it is contemplated that the CRSMs described herein may store instructions different than those corresponding to the methods described herein and may store instructions which may be performed by systems other than the systems described herein.

It is appreciated that although the details are explained with reference to a first user and a second user, there may be multiple second users (multiple memory receivers) for whom the first user may be created and stored respective video recordings. Each of the multiple second users may retrieve the respective video recordings after the first user has expired. Further, the details are explained with reference to the first user as the memory creator, however, it is appreciated that the details are equally applicable for multiple first users (memory creators) utilizing the services of the video management engine to create video recordings for their known ones.

The methods, systems, and CRSMs described herein may include the features or perform the functions described herein in association with any one or more of the other methods, systems, and CRSMs described herein.

In some embodiments the method or methods described above may be executed or carried out by a computing system including a tangible computer-readable storage medium, also described herein as a storage machine, which holds machine-readable instructions executable by a logic machine (i.e., a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions.

The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A method for sharing video recording of a first user with a second user, the method comprising:
enabling, by a memory creation engine, the first user to create a video recording via a first user device associated with the first user, the video recording being indicative of personal moments between the first user and the second user;
receiving, by the memory creation engine from the first user via the first user device, contact information of the second user;
storing, by the memory creation engine, the video recording of the first user in a user video database;
receiving, by the memory creation engine from the second user via a second user device associated with the second user, a request to access the stored video recording;
determining, by the memory creation engine, whether the first user has expired; and
upon a determination that the first user has expired, enabling, by the memory creation engine, the second user to access the video recording of the first user.

2. The method of claim 1, wherein receiving the contact information of the second user comprises receiving one or more of name, email, mobile number, and relationship of the second user.

3. The method of claim 1, further comprising enabling the first user to customize the video recording.

4. The method of claim 3, wherein customizing the video recording comprises receiving a user input indicative of selection of background, filter, and/or music, and further, adding the selected background, filter, and/or music to the video recording.

5. The method of claim 1, wherein receiving the request to access the stored video recording comprises generating a unique access code, sharing the unique access code with the second user, and enabling the second user to access the video recording by referencing the unique access code.

6. The method of claim 1, wherein determining whether the first user has expired comprises retrieving, via one or more audit units, data associated with the first user from remote servers.

7. The method of claim 1, wherein determining whether the first user has expired comprises receiving, from the second user via the second user device, a death certificate indicative of death of the first user.

8. The method of claim 1, wherein determining whether the first user has expired comprises comparing the data retrieved by one or more audit units, personal data associated with the first user stored in a user profile database, and data read from a death certificate, and further, upon a result of the comparison indicating a data match, concluding that the first user has expired.

9. The method of claim 1, wherein enabling the second user to access the video recording of the first user comprises enabling the second user to download the video recording on the second user device.

10. The method of claim 1, further comprising permanently deleting the video recording from the user video database upon a determination that the second user has accessed the video recording.

11. A memory creation engine comprising:
one or more processors; and
memory, operatively coupled to the one or more processors, comprising instructions, which in response to execution by the one or more processors, cause the one or more processors to perform or control performance of one or more operations that comprise:
enable a first user to create a video recording via a first user device associated with the first user, the video recording being indicative of personal moments between the first user and a second user;
receive, from the first user via the first user device, contact information of the second user;
store the video recording of the first user in a user video database;
receive, from the second user via a second user device associated with the second user, a request to access the stored video recording;
determine whether the first user has expired; and
upon a determination that the first user has expired, enable the second user to access the video recording of the first user.

12. The memory creation engine of claim 11, wherein the contact information of the second user comprises one or more of name, email, mobile number, and relationship of the second user.

13. The memory creation engine of claim 11, wherein the operations further comprises an operation to enable the first user to customize the video recording.

14. The memory creation engine of claim 13, wherein the operation to customize the video recording comprises an operation to receiving a user input indicative of selection of background, filter, and/or music, and further, adding the selected background, filter, and/or music to the video recording.

15. The memory creation engine of claim 11, wherein the operation to receive the request to access the stored video recording comprises an operation to generate a unique access code, share the unique access code with the second user, and enable the second user to access the video recording by referencing the unique access code.

16. The memory creation engine of claim 11, wherein the operation to determine whether the first user has expired comprises an operation to retrieve, via one or more audit units, data associated with the first user from remote servers.

17. The memory creation engine of claim 11, wherein the operation to determine whether the first user has expired comprises an operation to receive, from the second user via the second user device, a death certificate indicative of death of the first user.

18. The memory creation engine of claim 11, wherein the operation to determine whether the first user has expired comprises an operation to compare the data retrieved by one or more audit units, personal data associated with the first user stored in a user profile database, and data read from a death certificate, and further, upon a result of the comparison indicating a data match, conclude that the first user has expired.

19. The memory creation engine of claim 11, further comprising an operation to permanently delete the video recording from a user video database upon a determination that the second user has accessed the video recording.

20. A non-transitory computer-readable storage medium comprising instructions, which in response to execution by one or more processors, cause the one or more processors to perform or control performance of one or more operations that comprise:
enable a first user to create a video recording via a first user device associated with the first user, the video recording being indicative of personal moments between the first user and a second user;
receive, from the first user via the first user device, contact information of the second user;
store the video recording of the first user in a user video database;
receive, from the second user via a second user device associated with the second user, a request to access the stored video recording;
determine whether the first user has expired; and
upon a determination that the first user has expired, enable the second user to access the video recording of the first user.
